(19) United States
(12) Patent Application Publication
(10) Pub. No.: US 2017/0108338 A1
(43) Pub. Date: Apr. 20, 2017

(54) METHOD FOR GEOLOCATING A CARRIER BASED ON ITS ENVIRONMENT

(71) Applicant: COMMISSARIAT A L'ENERGIE ATOMIQUE ET AUX ENERGIES ALTERNATIVES, PARIS (FR)

(72) Inventors: Dorra LARNAOUT, ARCUEIL (FR); Steve BOURGEOIS, CHOISY-LE-ROI (FR); Vincent GAY-BELLILE, PARIS (FR); Michel DHOME, POINT DU CHATEAU (FR)

(73) Assignee: Commissariat A L'Energie Atomique et Aux Energies Alternatives, Paris (FR)

(21) Appl. No.: 15/128,597

(22) PCT Filed: Mar. 23, 2015
(86) PCT No.: PCT/EP2015/056037

§ 371 Date: Sep. 23, 2016

(30) Foreign Application Priority Data
Mar. 31, 2014 (FR) 1452786

(51) Int. Cl. G01C 21/00; G01C 21/20; H04W 4/02; G01S 19/48

(52) U.S. Cl. CPC G01C 21/005; G01S 19/48; G01C 21/20; G01C 21/206; H04W 4/021

(57) ABSTRACT

A method for geo-localizing a carrier, comprises: acquiring a plurality of shots of the environment of the carrier; determining at least one datum relating to the position of the carrier for a set of shots; generating a virtual reconstruction of the environment from the shots of the set, from the positional data and from a measurement bias parameter for each position, the virtual reconstruction being parameterized depending on the measurement bias; and modifying the measurement bias parameter to be applied at each position to obtain a virtual reconstruction parameterized by a modified measurement bias, the modification being carried out so as to minimize the distance between the modified virtual reconstruction and an a priori virtual representation of the environment.

The invention relates to the field of systems for geo-localizing, in an exterior environment, for example a road, or an interior environment, for example the interior of a building.

The invention more precisely relates to a method and system for geo-localizing a carrier, especially a mobile carrier, that allows the carrier to be accurately positioned in a virtual reconstruction of its environment obtained from shots taken with a system for observing the environment.

Systems for localizing by triangulation, for example satellite positioning systems, systems using localized Wi-Fi terminals or cell-phone-network-based systems, are generally subject to localizing errors that may be modeled by a measurement noise and a bias. The noise is generally random and of small magnitude. The measurement bias is for its part generally larger and substantially stable over a relatively limited period of time and in a given spatial region.

The existence of a measurement bias directly impacts these geo-localizing systems, which require the required positioning to be highly accurate. One technical problem to solve consists in finding a solution allowing this measurement bias to be corrected or compensated for in order to make the positioning more accurate.

Estimation of measurement bias nevertheless remains complex since the latter may be related to a combination of effects that are as different as the nature of the materials passed through by the triangulation signal, the effect of multiple reflections of the emitted signal on its path to the receiver, the use of a small number of visible emitters, emitter positioning errors or even a poor clock synchronization between the various emitters.

To estimate the bias affecting the navigational data generated by a system for localizing by triangulation, methods based on the measurement of the vector relating the current position delivered by the system for localizing by triangulation to that delivered by a system for perceiving the environment, are known. Such methods are especially described in documents [1] and [2], which describe a perceiving system based on a video camera, and in document [3], which describes a solution based on a pair of video cameras or stereo head. Other systems for perceiving the environment, such as lidar or radar systems, have also been envisioned in the prior art.

In the aforementioned methods of the prior art, the measurement of said vector generally involves uncertainties associated with each measurement of position, i.e. both the measurements delivered by the system for localizing by triangulation and those delivered by the perceiving system. This measurement is completed using a prediction of the measurement bias and its associated uncertainty, which is based on a model of the variation in the bias and which is estimated using Kalman-filter ([1]) or particle-filter ([2]) type filtering methods. These filtering type estimating methods thus make it possible to take into account the fact that the bias may sometimes be stable from one measurement to another or vary slowly.

The methods described in the three aforementioned documents however have a number of drawbacks as regards their robustness.

Firstly, the methods used to predict and update the estimation of the bias are not robust to the presence of erroneous estimations of the bias.

Specifically, these methods do not allow the estimations, made at a prior instant, of the value of the uncertainty of the bias to be reconsidered because said estimations are not re-evaluated. On the contrary, in the case of a poor estimation, the mechanism for predicting the bias and for propagating the associated uncertainty will tend to propagate the error made. In the specific case in which the predicted uncertainty is incompatible with the uncertainties estimated by the various localizing systems, certain systems propose to reset the estimation of the bias to zero (in other words to consider the bias to be zero with a high uncertainty). Although this is generally preferable to the propagation of a poor estimation, this solution leads to a loss of precision.

A second problem as regards the robustness of the methods known from the prior art is related to the fact that the position delivered by the perceiving system is based on matching current observations delivered by the perceiving sensor (for example the current image of the video camera in document [1], or the current reconstruction of a stereo head in document [3]) with a known map of the environment. One example of matching is the matching of the position of a pedestrian crossing in the image of a video camera with the position of this pedestrian crossing on a roadmap. To be able to make this match, the known solutions exploit the estimated position at the current instant of the system.

This approach especially has two drawbacks. Firstly, since the navigational data delivered by the localizing system are used as an a priori to guide the matching, the absence of an estimation of the measurement bias in these data or an inaccurate estimation or even an erroneous estimation of said bias may distort this matching step.

Secondly, even in the presence of a correct estimation of the measurement bias in the navigational data, it is not realistic to consider the localization delivered by the system for perceiving the environment to be completely reliable. Specifically, using only the observations delivered at the current instant by the perceiving system may prove not to be discriminatory enough to allow an accurate match with the map to be obtained, because of the existence of localization ambiguities. For example, a crossroad with a high concentration of pedestrian crossings risks causing an association error. An association error may arise and lead to a localization the uncertainty of which is very under evaluated, or even inconsistent with the local localization. Thus, as indicated above, the process for estimating biases is not very robust to aberrant data.

In document [3], the authors propose to localize a system fitted with a GPS receiver, an inertial measurement unit and a pair of video cameras. The system uses the data delivered by all of the sensors to estimate the position of the system using a particle-filter algorithm. To estimate the bias affecting the data delivered by the GPS receiver, this solution proposes to align the reconstruction of the environment delivered at the current instant by the pair of cameras with a three-dimensional map of the environment.

This approach proves to be limited in terms of robustness and precision. Specifically, the alignment of a single stereo reconstruction with a 3-D model of the environment may prove to be ambiguous when the geometry of the observed scene contains repetitive structures or a single very simple structure. For example, the observation of a flat wall does not allow the position of the system to be constrained with respect to a translation parallel to the wall. The system for perceiving the environment therefore risks delivering an erroneous localization that will distort the estimation of bias. In such a specific case, the GPS bias risks either being poorly estimated (poor pairing) or being estimated infrequently (the system identifies the pairing problem and decides not to estimate the bias).

The present invention aims to remedy the drawbacks of the prior-art solutions by providing a method for geo-localizing the environment of a carrier that exploits both navigational data delivered by a system for localizing by triangulation and a virtual reconstruction of the environment delivered by a perceiving system, and that allows measurement bias in the navigational data to be corrected.

The approach proposed by the invention makes it possible to obtain a more accurate and more robust estimation of the bias of the localizing system. In the nonlimiting case where the perceiving system is a stereo head, instead of considering only a stereo reconstruction delivered by the stereo head at the current instant, the invention allows the N last observations of this stereo head to be exploited to create a more complete reconstruction of the environment respecting the constraints of the multi-view geometry generated by the set of stereo image pairs. The obtained reconstruction, although imperfect, has a better discriminating power in the step of matching with a 3-D map of the environment since this reconstruction covers a larger region of the scene, thereby decreasing the probability that the latter will include only repetitive structures or a structure that is too simple. The invention therefore has the advantage of enabling robust matching, thereby limiting the risk of aberrant data.

In addition, the bias estimated by virtue of the method according to the invention is that for which a reconstruction generated from the N last observations of the stereo head aligns best with the 3-D map of the environment while meeting, in this case, the constraints of the multi-view geometry. The presence of these multi-view constraints and the fact that the bias affecting the data is estimated holistically decreases the probability that a local reconstruction error by the stereo head will be able to distort the estimation of the bias. The fact that the bias of each navigational datum is re-estimated at each instant allows past estimations to be reconsidered, and thus the detection and correction of erroneous bias estimations to be promoted.

One subject of the invention is a method for geo-localizing the environment of a carrier, comprising the following steps:
Acquiring a plurality of shots of the environment of the carrier;
Determining at least one datum relating to the position of the carrier for a set of shots;
Generating a virtual reconstruction of the environment from the shots of said set, from the positional data and from a measurement bias parameter for each position, said virtual reconstruction being parameterized depending on the measurement bias; and
Modifying the measurement bias parameter to be applied at each position to obtain a virtual reconstruction parameterized by a modified measurement bias, the modification being carried out so as to minimize the distance between said modified virtual reconstruction and an a priori virtual representation of the environment.

According to one particular embodiment of the invention, the generation of a virtual reconstruction of the environment comprises:
Correcting each navigational datum with a bias parameter; and
Generating a virtual reconstruction of the environment from the plurality of shots and corrected positional data.

According to one particular embodiment of the invention, the generation of a virtual reconstruction of the environment comprises:
Generating a virtual reconstruction of the environment from the plurality of shots; and
Applying, to said virtual reconstruction, a deformation calculated from positional data and bias parameters.

According to one particular embodiment of the invention, the generation of a virtual reconstruction of the environment comprises generating a plurality of geometric elements parameterized by said measurement bias, and defining said reconstruction and the modification of the virtual reconstruction of the environment comprises the following substeps, which are executed iteratively:
A step of matching a plurality of parameterized geometric elements of the virtual reconstruction with a plurality of fixed geometric elements of the a priori virtual representation;
A step of calculating at least one distance between a plurality of parameterized geometric elements of said virtual reconstruction and a plurality of corresponding fixed geometric elements in said a priori representation; and
A step of modifying said measurement bias parameter so as to minimize said distance.

According to one particular embodiment of the invention, the same bias value is associated with a group of shots.

According to one particular embodiment of the invention, the values of the biases associated with the various shots are related to one another by a parametric or nonparametric model.

According to one particular embodiment of the invention, said set of shots is taken in a moving window that is mobile in time or in space.

According to one particular embodiment of the invention, the distance between said virtual reconstruction and the a priori virtual representation is a point-to-point or point-to-plane or plane-to-plane distance in space or a reprojection error in the plane or a combination of a plurality of these distances.

According to one particular embodiment of the invention, the a priori virtual representation of the environment is a cartographic representation comprising at least one model selected from a terrain elevation model, a three-dimensional model of the buildings of a geographical zone, a three-dimensional point cloud, an architectural plan.

According to one particular embodiment of the invention, the acquisition of a plurality of shots of the environment of the carrier is carried out using a system for perceiving the environment of the carrier.

According to one particular embodiment of the invention, the determination of at least one navigational datum of the carrier for a set of shots is carried out using a system for localizing by triangulation.

Other subjects of the invention are a computer program including instructions for executing the method for geo-localizing the environment of a carrier according to the invention, when the program is executed by a processor, and a processor-readable storage medium on which is stored a program including instructions for executing the method for geo-localizing the environment of a carrier according to the invention, when the program is executed by a processor.

Yet another subject of the invention is a geo-localizing system with which a carrier is intended to be equipped, comprising a system for perceiving the environment of the carrier, able to acquire a plurality of shots, a system for localizing by triangulation, able to deliver at least one navigational datum for each shot, a database containing an a priori virtual representation of the environment and a processor configured to execute the method for geo-localizing the environment of a carrier according to the invention in order to produce a geo-localized virtual reconstruction of the environment of the carrier.

The system for perceiving the environment of the carrier may be a video camera taking two-dimensional shots or a pair of video cameras taking two-dimensional shots or a video camera taking three-dimensional shots or a lidar system or a radar system.

The system for localizing by triangulation may be a satellite geo-localizing system or a Wi-Fi geo-localizing system or a cell-phone-network-based geo-localizing system.

Other features and advantages of the present invention will become more clearly apparent on reading the following description with regard to the appended drawings, which show:

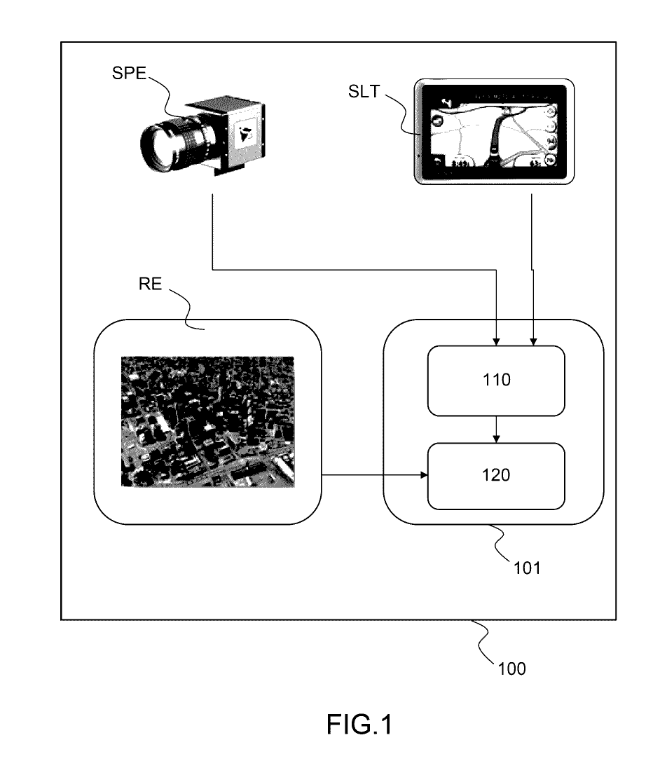

FIG. 1, an overview of a geo-localizing system according to the invention; and

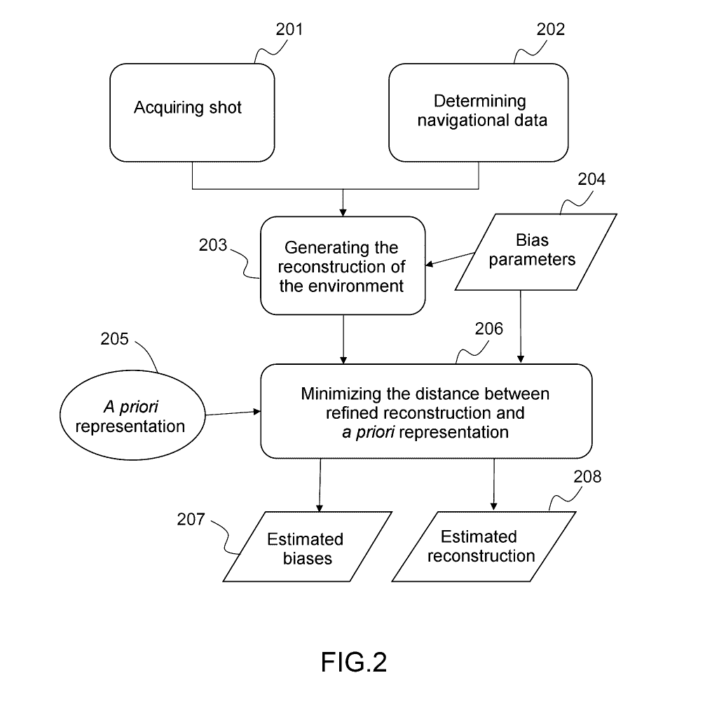

FIG. 2, a flowchart illustrating the steps of the method according to the invention.

FIG. 1 shows an overview of a geo-localizing system 100 according to the invention, which is intended to be installed on an optionally mobile carrier, a vehicle for example.

Such a system includes a system SPE for perceiving the environment, which is able to capture shots of the environment of the geo-localizing system 100. The system SPE for perceiving the environment may comprise but is not limited to a video camera taking two-dimensional shots, a pair of video cameras taking two-dimensional shots, a camera taking three-dimensional shots, a lidar system or a radar system. Any other equivalent device allowing a plurality of shots of the environment to be acquired is compatible with the system 100 according to the invention.

The system 100 according to the invention also includes a system SLT for localizing by triangulation, which may comprise but is not limited to a GNSS receiver, a GPS receiver for example, a receiver for localizing based on a Wi-Fi network or on a cell-phone network or any other system allowing navigational data relating to the carrier of the system 100 to be obtained. The navigational data especially comprise any datum relating to the position of the system 100 or any datum allowing information on the position of the system 100, in particular its speed or acceleration, to be deduced indirectly.

The system 100 according to the invention also includes a database containing an a priori representation of the environment RE, which may take the form of a cartographic representation of the environment in which the carrier of the system 100 is assumed to move, taking various forms including, nonlimitingly, a model of terrain elevation, a three-dimensional model of buildings of a geographical region, a three-dimensional point cloud, an architectural plan of a building but also data generated by a geographical information system (GIS) or a visual exploration representation software program.

The system 100 according to the invention also includes a processor 101 comprising a first computational module 110 configured to generate a virtual reconstruction of the environment from the captured shots, from the navigational data associated with these shots and from a measurement bias. The processor 101 also includes a second computational module 120 configured to compare the virtual reconstruction determined by the first computational module 110 with the a priori representation of the environment stored in the database in order to deduce therefrom the precise geo-localization of this reconstruction of the environment and an estimate of the measurement bias affecting the navigational data.

The computing steps implemented by the processor 101 are described further on in the description.

The processor 101 may be a generic processor, a specific processor, an application-specific integrated circuit (ASIC) or a field-programmable gate array (FPGA) or any other equivalent computational device.

The geo-localizing method according to the invention described below may be implemented as a computer program including instructions for its execution. The computer program may be stored on a storage medium readable by the processor 101.

FIG. 2 shows the steps of the geo-localizing method according to the invention in the form of a flowchart.

In a first step 201, the system SPE for perceiving the environment acquires a plurality of shots of the environment. In other words, if the perceiving system SPE consists of a video camera, the latter captures a plurality of images of the environment. This plurality of images may be composed of a plurality of images that are successive in temporal order or a plurality of images of a given scene taken from various spatial viewpoints.

In a second step 202, the localizing system SLT determines, for each shot of the environment, a datum on the position of the system 100. The estimated positions are marred by a measurement bias that it is sought to estimate accurately. The bias may be independent for each shot or may follow a variation respecting known properties, for example a model of variation.

The principle behind the invention consists in estimating, for each shot, the bias 204 impacting the position estimated by the localizing system, which allows a virtual reconstruction of the environment as close as possible to an a priori representation 205 of the environment to be obtained.

In a third step 203, a geo-localized virtual reconstruction of the environment is generated from the various shots and from the positions associated with each shot. Furthermore, a bias parameter is associated with each position so as to produce a parameterized multi-view reconstruction depending on the bias values associated with each shot.

The generated virtual reconstruction is denoted M^{W}. The latter may consist of a set of points, of segments, of regions, of planes or indeed even of a mesh, a map of occupation, or a voluminal probabilistic representation. All these examples are given by way of illustration and are nonlimiting, any type of virtual representation of a scene may be envisioned by those skilled in the art.

To generate a reconstruction of the environment from the various shots, there are a plurality of prior-art algorithms that may be used depending on the sensor envisioned for the system for perceiving the environment. For example, if the sensor for perceiving the environment is a video camera then “slam” type algorithms such as those described in references [4] and [5] or “structure from motion” type algorithms such as those described in reference [13] allow a dense or sparse three-dimensional reconstruction of the environment to be obtained.

In the context of a lidar or laser sensor, the various discrete reconstructions may be agglomerated into a single consistent overall reconstruction via approaches of the ICP (iterative closest point) type such as described in publication [14].

The positions delivered by the localizing sensor, which are denoted P^{W}={P^{W}ⱼ}, i ranging from 1 to N where N is the number of shots, may be used directly by some of the aforementioned algorithms in order to obtain a three-dimensional reconstruction localized in a coordinate system W of the localizing system.

These positions are subjected to a bias parameter denoted b. The localized virtual reconstruction function allowing the reconstruction M^{W} of the environment to be obtained from the observations O={Oⱼ} (where j varies from 1 to N) issued from the N acquisitions of the perceiving system is then denoted f(O,P^{W},b).

Any other known method equivalent to those described in references [4], [5], [13] and [14] and which allows a geo-localized virtual representation of a visual environment to be obtained from a plurality of shots of this environment and associated localizations may be used instead of the referenced methods. Mention may also be made of the methods described in documents [6] and [7].

According to a first variant embodiment of step 203 of the method according to the invention, the parameterized virtual reconstruction of the environment may be generated by correcting beforehand each positional datum with a bias parameter then by generating the virtual reconstruction from shots and corrected positions parameterized by the bias.

According to a second variant embodiment of step 203 of the method according to the invention, the parameterized virtual reconstruction of the environment may be generated directly from the shots. The reconstruction function applied to the observations O to obtain the reconstruction M^{L} in a geometric coordinate system L that is potentially different from the coordinate system W attached to the localizing system SLT is denoted g.

In a subsequent step, a deformation A is calculated from the data P^{W} generated by the system for localizing by triangulation and from bias parameters b associated with each of the localization data obtained by triangulation. The deformation A is applied to the reconstruction M^{L} in order that the latter is expressed in the coordinate system W of the localizing system and is consistent with the data generated by the system for localizing by triangulation. The deformation A used may be a similarity transformation or indeed a more sophisticated approach that takes into account local positioning errors such as for example the estimation of a nonrigid transformation, for example a B-Spline or TPS (Thin Plate Spline) deformation.

In a fourth step 206, the parameterized reconstruction obtained at the end of the third step 203 is compared with the a priori representation of the environment 205 with the aim of finding optimal values of the bias parameters to be applied to each view to obtain a reconstruction of the environment that is as similar as possible to the a priori representation.

The main origin of the shift between the reconstruction M^{W} and the a priori representation of the environment A^{W} is the bias in the localizing sensor. Other sources of errors are local inaccuracies due to the method for reconstructing the virtual environment or even imperfect environment a prioris.

The optimal values of the bias parameters affecting the localizing sensor are those that engender the virtual reconstruction of the environment that aligns the best with the a priori of the environment. Thus the bias parameters b are estimated by minimizing an error between the virtual reconstruction and the a priori representation of the environment. This error may be calculated as a distance between the reconstruction and the a priori representation, the problem to be solved then consisting in finding the values of the bias parameters b={bᵢ}, for i ranging from 1 to N, that minimize the distance d, which may be expressed as the minimization of the cost function F(b)=d(f(O,P^{W},b), Δ^{W}). Since a modification of the bias engenders a modification in the reconstruction via the function f(O,P^{W},b), the virtual reconstruction of the environment is re-estimated during the minimization process thus allowing the initial reconstruction, which was marred by errors because of the bias, to be reconsidered.

The distance d gives information on the differences between the reconstruction and the a priori representation. Any geometric distance allowing information to be obtained on these differences may be envisioned. In particular, the distance d may be a point-to-point or point-to-plane or plane-to-plane distance in space or a reprojection error in the plane such as introduced in documents [17] and [18] or a combination of a plurality of these distances.

More generally, the distance d is calculated between two corresponding geometric elements, for example between a point of the virtual reconstruction and the corresponding point in the a priori representation of the environment.

The cost function F(b) may be minimized by any known linear or non-linear optimization algorithm, for example the Levenberg Marquardt algorithm described in document [15] or the solutions described in articles [20], [21], [22] and [23].

When the correspondences between the reconstruction and the a priori representation are not known, a two-step approach is used. In a first step, a match is chosen between the geometric elements of the reconstruction and those of the a priori representation, then in a second step the cost function F(b) is minimized. These two steps may be iterated a plurality of times in order to reconsider the complete process of re-construction in light of the changes in bias on each iteration of the optimization, this thus allowing local inaccuracies in the reconstruction to be taken into account. Such an iterative approach is especially described in document [16].

The result of the operation of minimizing the cost function F(b) makes it possible to obtain optimal bias values b={bᵢ} allowing the positional data to be corrected and also makes it possible to obtain a virtual reconstruction geo-localized at a position the accuracy of which is improved with respect to that obtained by exploiting alone data delivered by a system for localizing by triangulation.

According to one variant embodiment of the invention, the same bias parameter value may be applied to a group of shots depending on data external to the system. For example, an assumption may be made as regards the variation over time in the bias over the horizon of the number of exploited shots. In other words, the bias may be assumed to be constant over a duration equivalent to a plurality of shots.

Taking into account assumptions as regards variations in the bias makes it possible to decrease the number of parameters in the cost function to be minimized and therefore to decrease complexity.

External data may be taken into account to refine the model of variation in the bias. For example, in the case of a satellite positioning system, a datum relating to losses in the signal received by a satellite may be exploited to refine the assumed ranges of variations in the bias.

According to another variant embodiment of the invention, the various bias parameters may be related using a parametric model for example comprising a translation, a rigid transformation, a similarity transformation, a local similarity transformation, a B-Spline type deformation or a TPS (Thin Plate Spline) type transformation.

The bias parameters may also be related using a nonparametric model, for example a model based on a regularized deformation field.

The use of a parametric or nonparametric model to relate the bias parameters once again allows the number of parameters of the cost function to be limited and thus allows solution complexity to be decreased.

According to another variant embodiment of the invention, the shots retained are taken in a moving time window, thereby allowing the number of data to take into account for the virtual reconstruction to be decreased but also indirectly allowing the number of bias parameters to be limited.

In the case where a simultaneous localization and mapping type reconstruction method is used, the shots retained may be selected as key images.

The shots may also be selected within a spatial window, in other words a plurality of viewpoints of a given scene may be selected.

The invention allows an accurate geo-localization of the environment of a carrier to be delivered by compensating for the measurement bias of navigational data delivered by a system for localizing by triangulation.

In contrast to prior-art solutions, the invention is not based on estimating the measurement bias by a difference between the current position delivered by the system for localizing by triangulation and the current localization delivered by a perceiving system.

On the contrary, the invention uses a method for reconstructing the environment exploiting both the observations of the perceiving system and localization data delivered by a triangulation system, and a search for the bias values for which the correction of the bias in the reconstructing method allows the reconstruction of the environment to be best aligned with a geometric model of the environment known a priori.

The criteria used to characterize the quality of the estimation of the bias is therefore different from conventional criteria based on an alignment of the localization measurements of a triangulation system with those delivered by a perceiving system.

The criteria used by the invention could consist on the contrary in an alignment of the reconstruction with a model of the environment.

By using a reconstruction exploiting a plurality of observations of the perceiving system, additional geometric constraints are introduced, thereby making the system according to the invention more robust than conventional systems exploiting only current observations.

In addition, since this reconstruction covers a larger region of the environment, it is possible to establish an alignment with the a priori known geometric model with a higher certainty and with a higher frequency.

By re-estimating at each instant the bias for a set of triangulation data, the invention offers a better robustness to erroneous estimations because past estimations are reconsidered in light of new data delivered by the system for localizing by triangulation and by the perceiving system.

The method according to the invention allows the bias affecting the data generated by a system for localizing by triangulation to be estimated more accurately, more frequently and more robustly. This solution may be used with many systems for localizing by triangulation, many perceiving systems and many a priori geometric models of the environment.

In particular, the invention is able to function with low-cost sensors, such as a mass-market GPS receiver and a simple video camera, and a low-definition 3-D model of the environment. The ratio between on the one hand the cost and ease of deployment and on the other hand the quality and continuity of the localization service offered by this solution makes it possible to envision use in many applications, whether this be in the field of navigation assistance, for example augmented reality navigation, or in the field of autonomous vehicles or robots.

### REFERENCES

[1] J. Laneurit, R. Chapuis and F. Chausse, “Accurate Vehicle Positioning on a Numerical Map,” INTERNATIONAL JOURNAL OF CONTROL AUTOMATION AND SYSTEMS, 2005.
[2] K. C. M. S. Kichun Jo, “GPS-bias correction for precise localization of autonomous vehicles,” Intelligent Vehicles Symposium (IV), 2013 IEEE, 2013.
[3] L. D. D. Vernaza P., “Robust GPS/INS-aided localization and mapping via GPS bias estimation,” 10th International Symposium on Experimental Robotics, 2008.
[4] L. M. D. M. D. F. S. P. Mouragnon E., “Real-Time Localization and 3D Reconstruction,” IEEE Conference on Computer Vision and Pattern Recognition, 2006.
[5] K. Georg and M. David, “Parallel Tracking and Mapping for Small AR Workspaces,” International Symposium on Mixed and Augmented Reality, 2007.
[6] L. S.,. D. A. Newcombe Richard A., “DTAM: Dense tracking and mapping in real-time,” IEEE International Conference on Computer Vision, 2011.
[7] V. Pradeep, C. Rhemann, S. Izadi, C. Zach, M. Bleyer and S. Bathiche, “MonoFusion: Real-time 3D reconstruction of small scenes with a single web camera,” IEEE International Symposium on Mixed and Augmented Reality, 2013.
[8] R. A. Newcombe, S. Izadi, 0. Hilliges, D. Molyneaux, D. Kim, A. J. Davison, P. Kohli, J. Shotton, S. Hodges and A. Fitzgibbon, “KinectFusion: Real-Time Dense Surface Mapping and Tracking,” International Symposium on Mixed and Augmented Reality, 2011.
[9] M. Lhuillier, “Fusion of GPS and Structure-from-Motion using Constrained Bundle Adjustments,” IEEE Conference on Computer Vision and Pattern Recognition, 2011.
[10] C. Strecha, T. Pylvanainen and P. Fua, “Dynamic and scalable large scale image image reconstruction,” 3D Data Processing, Visualization and Transmission, 2010.
[11] R. S. Kaminsky, N. Snavely, S. M. Seitz and R. Szeliski, “Alignment of 3D point clouds to overhead image,” Workshop on Internet Vision, 2009.
[12] N. Sunderhauf, “Robust Optimization for Simultaneous Localization and Mapping,” (PhD), 2012.
[13] S. Agarwal, N. Snavely, I. Simon, S. Seitz and R. Szeliski, “Building Rome in a Day,” ICCV, 2009.
[14] W. D. Lui, T. J. J. Tang, T. Drummond and W. Li, “Robust egomotion estimation using ICP in inverse depth coordinates.,” ICRA, 2012.
[15] K. Levenberg, “ A method for the solution of certain non-linear problems in least squares.,” Quarterly of Applied Mathematics, 1944.
[16] R. M. Neal and G. E. Hinton, “A View of the EM Algorithm that Justifies Incremental, Sparse, and Other Variants.,” Learning in Graphical Models, 1998.
[17] P. Lothe, S. Bourgeois, F. Dekeyser, E. Royer and M. Dhome, “Towards Geographical Referencing of Monocular SLAM Reconstruction Using 3D City Models: Application to Real-Time Accurate Vision-Based Localization,” IEEE Conference on Computer Vision and Pattern Recognition, 2009.
[18] M. Tamaazousti, V. Gay-Bellile, S. Naudet-Collette, S. Bourgeois and M. Dhome, “NonLinear refinement of structure from motion reconstruction by taking advantage of a partial knowledge of the environment,” CVPR, 2011.
[19] C. -P. Wang, K. Wilson and N. Snavely, “Accurate georegistration of point clouds using geographic data,” 3DV, 2013.
[20] http://en.wikipedia.org/wiki/Iteratively_reweighted_least_squares
[21] http://en.wikipedia.org/wiki/Conjugate_gradient_method
[22] Lourakis, M. I A; Argyros, A. A., “Is Levenberg-Marquardt the most efficient optimization algorithm for implementing bundle adjustment?,” Computer Vision, 2005. ICCV 2005. Tenth IEEE International Conference on, vol. 2, no., pp. 1526, 1531 Vol. 2, 17-21 Oct. 2005
[23] http://en.wikipedia.org/wiki/Simulated_annealing

1. A method for geo-localizing a carrier, comprising:
acquiring a plurality of shots of the environment of the carrier;
determining at least one datum relating to the position of the carrier for a set of shots;
generating a virtual reconstruction of the environment from the shots of said set, from the positional data and from a measurement bias parameter for each position, said virtual reconstruction being parameterized depending on the measurement bias; and
modifying the measurement bias parameter to be applied at each position to obtain a virtual reconstruction parameterized by a modified measurement bias, the modification being carried out so as to minimize the distance between said modified virtual reconstruction and an a priori virtual representation of the environment.

2. The method for geo-localizing a carrier of claim 1, wherein the generation of a virtual reconstruction of the environment comprises:
correcting each navigational datum with a bias parameter; and
generating a virtual reconstruction of the environment from the plurality of shots and corrected positional data.

3. The method for geo-localizing a carrier of claim 1, wherein the generation of a virtual reconstruction of the environment comprises:
generating a virtual reconstruction of the environment from the plurality of shots; and
applying, to said virtual reconstruction, a deformation calculated from positional data and bias parameters.

4. The method for geo-localizing a carrier of claim 1, wherein the generation of a virtual reconstruction of the environment comprises generating a plurality of geometric elements parameterized by said measurement bias, and defining said reconstruction and the modification of the virtual reconstruction of the environment comprises the following substeps, which are executed iteratively:
matching a plurality of parameterized geometric elements of the virtual reconstruction with a plurality of fixed geometric elements of the a priori virtual representation;
calculating at least one distance between a plurality of parameterized geometric elements of said virtual reconstruction and a plurality of corresponding fixed geometric elements in said a priori representation; and
modifying said measurement bias parameter so as to minimize said distance.

5. The method for geo-localizing the environment of a carrier of claim 1, wherein the same bias value is associated with a group of shots.

6. The method for geo-localizing the environment of a carrier of claim 1, wherein the values of the biases associated with the various shots are related to one another by a parametric or nonparametric model.

7. The method for geo-localizing the environment of a carrier of claim 1, wherein said set of shots is taken in a moving window that is mobile in time or in space.

8. The method for geo-localizing the environment of a carrier of claim 1, wherein the distance between said virtual reconstruction and the a priori virtual representation is a point-to-point or point-to-plane or plane-to-plane distance in space or a reprojection error in the plane or a combination of a plurality of these distances.

9. The method for geo-localizing the environment of a carrier of claim 1, wherein the a priori virtual representation of the environment is a cartographic representation comprising at least one model selected from a terrain elevation model, a three-dimensional model of the buildings of a geographical zone, a three-dimensional point cloud, an architectural plan.

10. The method for geo-localizing the environment of a carrier of claim 1, wherein the acquisition of a plurality of shots of the environment of the carrier is carried out using a system for perceiving the environment of the carrier.

11. The method for geo-localizing the environment of a carrier of claim 1, wherein the determination of at least one navigational datum of the carrier for a set of shots is carried out using a system for localizing by triangulation.

12. A computer program including instructions, stored on a tangible non-transitory storage medium, for executing on a processor a method for geo-localizing a carrier comprising:
acquiring a plurality of shots of the environment of the carrier;
determining at least one datum relating to the position of the carrier for a set of shots;
generating a virtual reconstruction of the environment from the shots of said set, from the positional data and from a measurement bias parameter for each position, said virtual reconstruction being parameterized depending on the measurement bias; and
modifying the measurement bias parameter to be applied at each position to obtain a virtual reconstruction parameterized by a modified measurement bias, the modification being carried out so as to minimize the distance between said modified virtual reconstruction and an a priori virtual representation of the environment.

13. A tangible non-transitory processor-readable recording medium on which is stored a program including instructions for executing a method for geo-localizing a carrier comprising:
acquiring a plurality of shots of the environment of the carrier;
determining at least one datum relating to the position of the carrier for a set of shots;
generating a virtual reconstruction of the environment from the shots of said set, from the positional data and from a measurement bias parameter for each position, said virtual reconstruction being parameterized depending on the measurement bias; and
modifying the measurement bias parameter to be applied at each position to obtain a virtual reconstruction parameterized by a modified measurement bias, the modification being carried out so as to minimize the distance between said modified virtual reconstruction and an a priori virtual representation of the environment.

14. A geo-localization system with which a carrier is intended to be equipped, comprising a system for perceiving the environment of the carrier, able to acquire a plurality of shots, a system for localizing by triangulation, able to deliver at least one navigational datum for each shot, a database containing an a priori virtual representation of the environment and a processor configured to execute a method for geo-localizing a carrier, in order to produce a geo-localized virtual reconstruction of the environment of the carrier, the method comprising:
acquiring a plurality of shots of the environment of the carrier;
determining at least one datum relating to the position of the carrier for a set of shots;
generating a virtual reconstruction of the environment from the shots of said set, from the positional data and from a measurement bias parameter for each position, said virtual reconstruction being parameterized depending on the measurement bias; and
modifying the measurement bias parameter to be applied at each position to obtain a virtual reconstruction parameterized by a modified measurement bias, the modification being carried out so as to minimize the distance between said modified virtual reconstruction and an a priori virtual representation of the environment.

15. The geo-localization system of claim 14, wherein the system for perceiving the environment of the carrier is a video camera taking two-dimensional shots or a pair of video cameras taking two-dimensional shots or a video camera taking three-dimensional shots or a lidar system or a radar system.

16. The geo-localization system of claim 15, wherein the system of localization by triangulation is a satellite geo-localizing system or a Wi-Fi geo-localization system or a cell-phone-network-based geo-localization system.
